(19) United States
(12) Patent Application Publication
(10) Pub. No.: US 2026/0118591 A1
(43) Pub. Date: Apr. 30, 2026

(54) DUPLEX FIBER OPTIC CONNECTOR STRUCTURALLY CONFIGURED TO MOUNT A CABLE IDENTIFIER HOLDER TO ENHANCE FIBER IDENTIFICATION AND CABLE MANAGEMENT

(71) Applicant: BELDEN CANADA ULC, SAINT-LAURENT (CA)

(72) Inventor: Mads FYNBOE, Hoejbjerg (DK)

(73) Assignee: BELDEN CANADA ULC, SAINT-LAURENT (CA)

(21) Appl. No.: 19/004,851

(22) Filed: Dec. 30, 2024

Related U.S. Application Data
(60) Provisional application No. 63/616,500, filed on Dec. 29, 2023.

(51) Int. Cl. G02B 6/36

(52) U.S. Cl. CPC G02B 6/3616

(57) ABSTRACT

A duplex fiber optic connector may include a cable holding portion with a first cable holding portion that holds a first fiber optic cable and a second cable holding portion that holds a second fiber optic cable. The first cable holding portion may provide a first coupling portion while the second cable holding portion provides a second coupling portion. The first cable holding portion and the second cable holding portion may provide a third coupling portion. The first coupling portion, second coupling portion, and third coupling portion may respectively slidingly receive an identifier retaining portion in different orientations such that the first, second, and third coupling portions permit selective attachment of the identifier retaining portion in the first orientation, the second orientation, or the third orientation so as to enhance fiber identification and cable management.

### CROSS-REFERENCE TO RELATED APPLICATION

This application claims the benefit of U.S. Provisional Ser. No. 63/616,500, filed on Dec. 29, 2023, the disclosure of which is hereby incorporated by reference herein in its entirety.

### TECHNICAL FIELD

The present disclosure is directed to fiber cable identification and management and, more particularly, to a duplex fiber optic connector structurally configured to mount a cable identifier holder to enhance fiber identification and cable management.

### BACKGROUND

Advancements in technology have resulted in greater volumes of digital information being generated, transferred, stored, and retrieved. Such digital information may be transferred via wireless or wired connections. While wireless communications can satisfy some consumer requirements, a majority of digital information is transferred by wired signal pathways that may provide greater reliability, security, and speed than wireless signal carrying counterparts. Hence, with larger volumes of digital information being generated and consumed, greater amounts of wired connections may be employed to satisfy consumer demand.

The use of signal carrying cable connections may pose inefficiencies during initial installation and over time. For instance, wired cables may be involved in maintenance of signal connections as well as changes in connected devices configurations, which may result in cables being frequently installed, uninstalled, physically connected, and physically disconnected over time. Once installed, the identification of cables, connections, and connected ports may pose additional inefficiencies, particularly when large volumes of cables are concurrently present, such as in a data center. Accordingly, embodiments are generally directed to a system that utilizes one or more cable clips to increase the efficiency of cable management and identification of ports engaged by various cables.

### SUMMARY

In accordance with various aspects of the disclosure, a duplex fiber optic connector may include a cable holding portion and an identifier retaining portion coupling portion. The cable holding portion may have a first cable engaging portion and a second cable engaging portion disposed parallel to one another and spaced apart from one another to define a first cable receiving portion structurally configured to receive a first fiber optic cable and a first holding portion structurally configured to hold the first fiber optic cable. The cable holding portion may have a third cable engaging portion and a fourth cable engaging portion disposed parallel to one another and spaced apart from one another to define a second cable receiving portion structurally configured to receive a second fiber optic cable and a second holding portion structurally configured to hold the second fiber optic cable. The body portion may have a middle portion between the first cable holding portion and the second cable holding portion. The first cable holding portion may be aligned with the second cable holding portion along a transverse axis of the body portion. The first cable receiving portion and the second cable receiving portion may be disposed at opposite sides of the body portion along the transverse axis such that the first cable receiving portion and the second cable receiving portion are structurally configured to receive a fiber optic cable in a direction of the transverse axis. The identifier retaining portion coupling portion may have a first coupling portion, a second coupling portion, and a third coupling portion. The first cable engaging portion and the second cable engaging portion may be structurally configured to provide the first coupling portion at the first cable receiving portion. The third cable engaging portion and the fourth cable engaging portion may be structurally configured to provide the second coupling portion at the second cable receiving portion. The second cable engaging portion and the fourth cable engaging portion may be structurally configured to provide the third coupling portion at a bottom portion of the body portion. The first coupling portion may be structurally configured to slidingly receive an identifier retaining portion in a first orientation, the second coupling portion may be structurally configured to slidingly receive the identifier retaining portion in a second orientation, and the third coupling portion may be structurally configured to receive the identifier retaining portion in a third orientation such that the identifier retaining portion coupling portion permits selective attachment of the identifier retaining portion in the first orientation, the second orientation, or the third orientation so as to enhance fiber identification and cable management.

In some embodiments, a duplex connector may configure the third coupling portion to receive a second same duplex connector to provide a quad cable configuration. A duplex connector assembly may have a duplex connector and an identifier retaining portion structurally configured to retain a cable identifier. The duplex connector assembly may additionally have a cable identifier configured to be received by the identifier retaining portion. In some embodiments, the cable identifier may be an RFID tag.

In accordance with various aspects of the disclosure, a duplex fiber optic connector, may include a cable holding portion and an identifier retaining portion coupling portion. The cable holding portion may have a first cable engaging portion and a second cable engaging portion disposed parallel to one another and spaced apart from one another to define a first cable holding portion structurally configured to hold a first fiber optic cable. The cable holding portion may have a third cable engaging portion and a fourth cable engaging portion disposed parallel to one another and spaced apart from one another to define a second cable holding portion structurally configured to hold a second fiber optic cable. The identifier retaining portion coupling portion may have a first coupling portion, a second coupling portion, and a third coupling portion. The first cable engaging portion and the second cable engaging portion may provide the first coupling portion. The third cable engaging portion and the fourth cable engaging portion may provide the second coupling portion. The second cable engaging portion and the fourth cable engaging portion may provide the third coupling portion at a bottom portion of the body portion. The first coupling portion may slidingly receive an identifier retaining portion in a first orientation, the second coupling portion may slidingly receive the identifier retaining portion in a second orientation, and the third coupling portion may receive the identifier retaining portion in a third orientation such that the identifier retaining portion coupling portion permits selective attachment of the identifier retaining portion in the first orientation, the second orientation, or the third orientation so as to enhance fiber identification and cable management.

Assorted embodiments of the duplex connector may have the first cable holding portion aligned with the second cable holding portion along a transverse axis of the body portion with the first cable holding portion and the second cable holding portion disposed at opposite sides of the middle portion along the transverse axis such that the first cable holding portion and the second cable holding portion are structurally configured to receive a fiber optic cable in a direction of the transverse axis. The duplex connector may dispose the first coupling portion at an opening to the first cable holding portion while the second coupling portion is disposed at an opening to the second cable holding portion. In accordance with some embodiments, the third coupling portion of the duplex connector may receive a second same duplex connector to provide a quad cable configuration. A duplex connector assembly may have a duplex connector and an identifier retaining portion structurally configured to retain a cable identifier. Embodiments of the duplex connector assembly may additionally have a cable identifier to be received by the identifier retaining portion, which in some embodiments may be an RFID tag.

In accordance with various aspects of the disclosure, a duplex fiber optic connector may include a first cable holding portion that may hold a first fiber optic cable and a second cable holding portion that may hold a second fiber optic cable. The first cable holding portion may provide a first coupling portion while the second cable holding portion may provide a second coupling portion. The first cable holding portion and the second cable holding portion may provide a third coupling portion. The first coupling portion may slidingly receive an identifier retaining portion in a first orientation. The second coupling portion may slidingly receive the identifier retaining portion in a second orientation. The third coupling portion may receive the identifier retaining portion in a third orientation such that the first, second, and third coupling portions permit selective attachment of the identifier retaining portion in the first orientation, the second orientation, or the third orientation so as to enhance fiber identification and cable management.

The duplex connector, in various embodiments, may configure the cable holding portion to include a first cable engaging portion and a second cable engaging portion disposed parallel to one another and spaced apart from one another to define the first cable holding portion with the cable holding portion having a third cable engaging portion and a fourth cable engaging portion disposed parallel to one another and spaced apart from one another to define the second cable holding portion. An embodiment of the duplex connector may align the first cable holding portion with the second cable holding portion along a transverse axis of the body portion while the first cable holding portion and the second cable holding portion are disposed at opposite sides of the middle portion along the transverse axis such that the first cable holding portion and the second cable holding portion are structurally configured to receive a fiber optic cable in a direction of the transverse axis. The duplex connector may dispose the first coupling portion at an opening to the first cable holding portion while the second coupling portion is disposed at an opening to the second cable holding portion. The duplex connector may configure the third coupling portion to receive a second same duplex connector to provide a quad cable configuration.

In accordance with some embodiments, a duplex connector assembly may have a duplex connector and an identifier retaining portion structurally configured to retain a cable identifier. The duplex connector assembly may additionally have a cable identifier configured to be received by the identifier retaining portion, which may be an RFID tag.

### BRIEF DESCRIPTION OF THE DRAWINGS

Further advantages and features of the present disclosure will become apparent from the following description and the accompanying drawings, to which reference is made.

FIG. 1 is a line representation of portions of a digital network environment in which assorted embodiments of a cable clip system may be practiced.

FIG. 2 is a line representation of portions of a cable assembly that may be employed in the environment of FIG. 1.

FIG. 3 is a line representation of portions of a cable clip that may be utilized in the cable assembly of FIG. 2 and the cable environment of FIG. 1.

FIG. 4 is a line representation of portions of a cable assembly arranged in accordance with various embodiments of this disclosure.

FIG. 5 is a perspective view of an exemplary duplex fiber optic connector in accordance with various embodiments of this disclosure.

FIG. 6 is a perspective view of an exemplary identifier holding portion and cable identifier for use with the connector of FIG. 5.

FIG. 7 is a perspective view of portions of an exemplary duplex connector assembly including the duplex fiber optic connector of FIG. 5.

FIG. 8 is a perspective view of portions of an exemplary duplex connector assembly including the duplex fiber optic connector of FIG. 5.

FIG. 9 is a perspective view of portions of an exemplary duplex connector assembly including the duplex fiber optic connector of FIG. 5.

FIG. 10 is a perspective view of another exemplary duplex fiber optic connector in accordance with various embodiments of this disclosure.

FIG. 11 is a perspective view of an exemplary identifier holding portion and cable identifier for use with the connector of FIG. 10.

FIG. 12 is a perspective view of portions of an exemplary duplex connector assembly including the duplex fiber optic connector of FIG. 10.

FIG. 13 is a perspective view of portions of an exemplary duplex connector assembly including the duplex fiber optic connector of FIG. 10.

FIG. 14 is a perspective view of another exemplary duplex fiber optic connector in accordance with various embodiments of this disclosure.

FIG. 15 is a perspective view of an exemplary identifier holding portion and cable identifier for use with the connector of FIG. 14.

FIG. 16 is a perspective view of portions of an exemplary duplex connector assembly including the duplex fiber optic connector of FIG. 14.

FIG. 17 is a perspective view of portions exemplary duplex connector assembly including the duplex fiber optic connector of FIG. 14.

### DETAILED DESCRIPTION

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The use of signal carrying cables to transfer digital information corresponds with installation of a cable connector into at least one device port. Connection of multiple separate cables into physically adjacent ports may present challenges for cable management, cable operation, and port identification. For these reasons, at least one cable clip may be utilized in accordance with various embodiments to improve cable operation reliability and management while increasing the efficiency of identifying available and/or occupied ports of a distributed digital network by supporting a wireless tag.

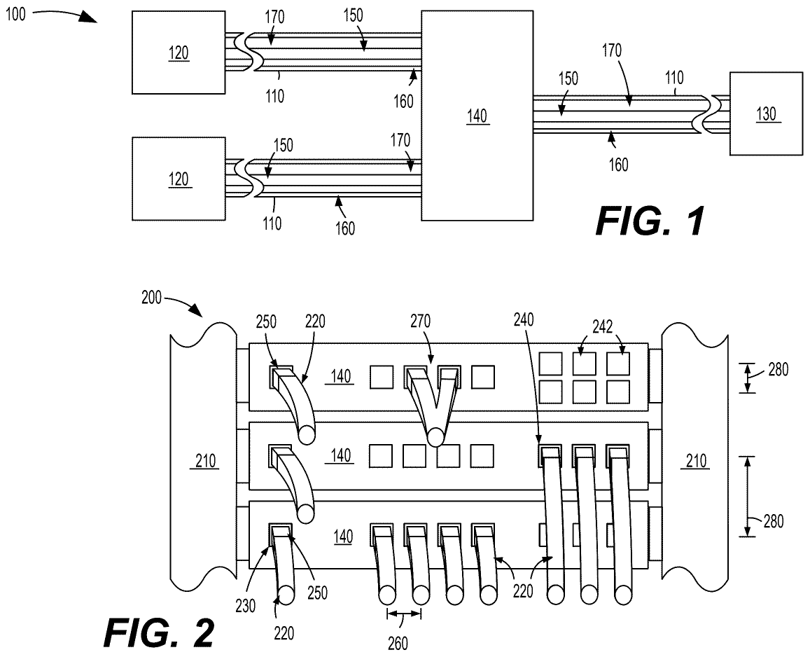

Turning to the drawings, FIG. 1 displays a block representation of portions of a distributed digital network environment 100 in which assorted embodiments of the present disclosure can be practiced. A cable 110, such as a coaxial cable or optical cable, can provide at least one stable signal pathway between a source 120 to a destination 130. A distributed digital network can employ any number, and type, of cable 110 to transfer digital signals in a signal direction, or dual directions, between sources 120 and destinations.

While a distributed digital network environment 100 may include a single source 120 connected to a single destination 130 via a single, continuously extending cable 110, such configuration is not required as one or more interconnects 140, such as a patch panel, switch, server, connector, splitter, or other device, can provide one or more stable signal pathways with numerous separate cables 110, as generally shown. The ability to use one or more interconnects 140 allows for the formation, operation, and maintenance of a distributed network where separate, and potentially different, sources 120 interact with separate, and potentially different, destinations 130.

A distributed digital network may utilize one or more cable assemblies, such as the assembly 200 shown as a line representation in FIG. 2, to provide stable signal carrying connections between any number of sources 120 and destinations 130. The cable assembly 200 is configured in accordance with various embodiments to provide multiple interconnects 140, such as a patch panel, switch, or server, in a rigid rack 210 that physically secures the respective interconnects 140 to allow efficient visual and physical access to assorted ports 220, lights, switches, and displays of the interconnects 140.

As shown in FIG. 2, the physical position and orientation of the respective interconnects 140 are uniform and matching throughout the rack 210. Such interconnect 140 configuration allows efficient visual and physical access to various input ports 230 and output ports 240 in a single plane facing away from the rack 210. It is contemplated that one or more of the interconnects 140 can be orientated differently so that cables 110/220, and ports 230/240 are directed towards a side of the rack 210 or opposite of the orientation shown in FIG. 2. The ability to utilize matching, or dissimilar, interconnects 140 along with the ability to configure the ports 230/240 to face various different directions relative to the rack 210 allows for diverse physical configurations that may promote efficient installation, maintenance, and removal over time.

The arrangement of the assorted ports 230/240 allows for increased density, and size utilization within the rack 210, while allowing sufficient cooling capabilities over time. However, the heightened density of interconnects 140 within the rack 210 can pose installation, port 230/240 identification, and cable management difficulties. For instance, placement of the various interconnect ports 230/240, particularly in duplex or quad arrangements where multiple cables 110/220 are placed in adjacent interconnect ports 242, may result in overlapping cables or obstructions that inhibit efficient physical and visual access to a cable connector 250 and port 230/240 identifier. As a result, cables 110/220 may be incorrectly installed into an interconnect port 230/240, incorrectly identified as connected to a port 230/240, or susceptible to movement of adjacent cables 110/220 that may disrupt the physical integrity, and connection, of one or more cable connectors 250.

Another specific, but non-limiting, example inadvertently disrupts the pitch 260 of adjacent cables arranged in a duplex or quad configuration. The pitch 260 can be characterized as a linear distance between the center of adjacent cables 110/220. A change from a desired pitch 260 can inhibit, or prevent, a proper connection with interconnect ports 242 signal carrying capabilities of a cable 110/220, particularly a cable configuration utilizing two or more cables 110/220 for signal carrying operation. It is noted that a single cable 270 can provide multiple conductors that concurrently connect to ports 230/240, which may also be susceptible to changes in pitch 260 due to encountered external force and diminish efficient port 230/40 identification by obscure greater amounts of the interconnect 140 than a single cable 110/220. Risk of inadvertent changes in pitch 260 may additionally be present when cables 110/220 are connected, or otherwise physically attached, across a vertical distance 280 between different ports 240/242 of one or more interconnects 140, which can be characterized as vertical pitch.

As shown in FIG. 2, mounting the interconnects 140 in the rack can provide easy access to the respective interconnects ports 230/240/242 individually, but can pose efficiency, organization, identification, management, and alteration difficulties over time when the rack 210 has multiple interconnects 140 occupied with various cables 110/220. For instance, input cables 110 can be difficult to discern from output cables 220 just as cables 110/220 connecting to one interconnect 140 can be difficult to discern from cables 110/220 connecting to other interconnects 140. In addition to organizational cabling issues, the threat of inadvertent physical force acting on a cable connector 250 may pose a risk of unwanted alteration of the operation of one or more port connections when handling and/or manipulating other cables 110/220 connected to the respective interconnects.

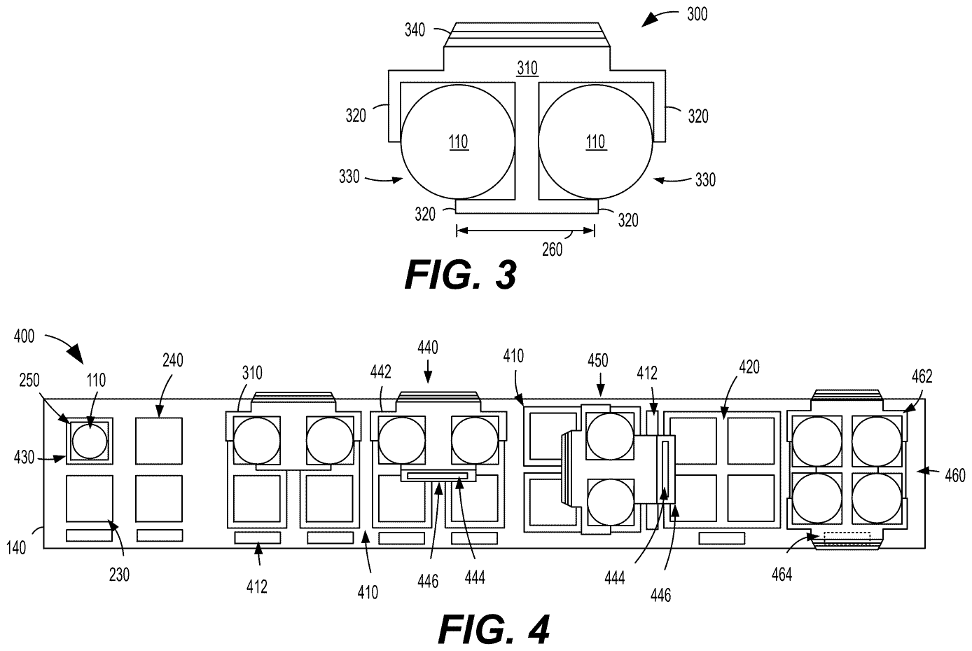

For cable configurations that involve multiple port connections for full performance, such as duplex or quad arrangements, a clip can provide cable organization while maintaining horizontal pitch 260. FIG. 3 is a line representation of a cable clip 300 that may be employed in the cable assembly 200 of FIG. 1 and the cable environment 100 of FIG. 1. The cable clip 300 utilizes a body portion 310 that may be constructed of one or more materials, components, or pieces that present retention portions 320 that physically engage portions of a cable 110. It is noted that while an input cable 110 is illustrated in FIG. 3, such configuration is not limiting and the clip body 310 can contact and retain an output cable 220 or a cable connector 250.

The number, size, and shape of the retention portions 320 may be arranged to provide one or more openings 330 that allow for ingress and egress of a cable 110. It is contemplated, but not required, that one or more of the retention portions 320 are configured to temporarily bend, or otherwise deform, to allow a cable 110 to be installed, or removed, from a retention cavity defined within the retention portions 320. Some embodiments of the retention portions 320 apply constant force onto a cable 110, when installed as shown in FIG. 3.

The cable clip 300 can employ one or more tab portions 340 cantilevered from the body portion 310 to provide articulable movement within a predetermined range. A tab portion 340 can extend from the body portion 310 to selectively engage aspects of a connector 250 or interconnect port 230/240 to facilitate cable 110 installation, or removal into an interconnect 140. In embodiments that do not utilize a tab portion 340, individual physical engagement of connector 250 would be necessary for cable 110 installation or removal. Hence, embodiments of the cable clip 300 can provide a single mechanism for physically selecting multiple cable connectors 250.

Through the utilization of one or more clip bodies 310 in a cable assembly 200, cable pitch 260 may be more reliably maintained than unsupported, individual cables 110. However, some clip bodies 310 may be limited with respect to providing physical stability and organization for more than a pair of cables 110. In addition, some clip body 310 configurations may further obscure portions of an interconnect 140 compared to an unsupported cable 110, which may make visual port identification difficult and inefficient.

FIG. 4 is a line representation of a cable assembly 400 in which assorted cable clips 300 are employed in accordance with various embodiments. The interconnect 140 has a number of duplex ports 410 and quad ports 420 that can be accessed and engaged with individual cables 110 or cables 110 secured within a clip, such as the cable clip 300 of FIG. 3. For illustration and in no way limiting, the interconnect of FIG. 4 has a variety of port identifiers 412 that are physically positioned proximal the corresponding port 230/240/410/420 to indicate information about one or more ports and/or port connections.

As shown, assorted single ports 230/240 can be visually inspected and physically engaged with an individual cable connector 250. Connection 430 illustrates how an individual connector 250 may occupy minimal area outside of the port 220, which easily allows for location and comprehension of the port identifiers 412, even if numerous adjacent ports 230/240 are occupied with cable connections 430. While separate cables 110 may be attached together with a cable clip despite not having a duplex or quad connection configuration, it is contemplated that non-duplex or non-quad ports 230/240 are positioned farther apart on the interconnect than ports designed for multiple cables 110 operating in conjunction to provide two-way signal communications.

It is noted that an interconnect 140 may provide only individual ports 230/240 arranged to be accessed by individual cable connections 430. However, increasing use of relatively sophisticated, multi-cable connections, such as duplex or quad connections, has resulted in greater demand for interconnects 140 with such ports 410/420. Use of a the cable clip from FIG. 3 to connect to a duplex port 420 can provide reliable and efficient maintenance of the cable pitch 260 for the duplex connection during installation, removal, and during operation.

Yet, the structure of the cable clip body 310 may obscure one or more port identifiers 412. As such, wireless tags may be employed to identify a cable, combination of cables, and corresponding ports and may supplement, or replace, physical port identifiers 412 to increase the efficiency and/or accuracy of associations of various separate cables 110 with various ports. Cable clip 440 illustrates how a cable clip body 442 may be arranged to retain a wireless tag 444 with a retention portion 446. The wireless tag 444 is not limited to a particular type, size, or capability, but in some embodiments utilizes radio frequencies to wirelessly communicate data to one or more receivers to identify at least the ports of the interconnect 140 occupied by cables 110 to form a connection.

The utilization of wireless tags to identify cables and/or ports may provide optimized speed and accuracy, particularly when numerous ports of an interconnect 140 are engaged with different cables 110 to form concurrent connections. However, the increased size of a cable clip body 442 corresponding with retaining a wireless tag 444 can physically impede and/or obscure greater area of an interconnect 140. As illustrated in FIG. 4, the incorporation of a wireless tag into a cable clip 440 can inhibit use of adjacent duplex ports 410. The difficulties associated with utilizing a cable clip 440 with wireless tag supporting capabilities may not be cured by orienting the clip 440 differently, as shown by duplex connection 450 where the retention portion 446 is oriented orthogonally from the configuration of the adjacent cable clip 440.

While it is conceived that ports adjacent to a cable clip 440 with wireless capabilities may be accessed and engaged, the subsequent cable connection has a high risk of being unreliable over time as undue physical stress on cables 110 over time can jeopardize the intended cable pitch and duplex connection integrity.

Wireless tag may be attached without a clip, but is physically unreliable to remain over time. In quad connections 460 where four cables 110 engage adjacent interconnect ports 420 to provide a two-way signal communication, the size of a cable clip 462 to reliably retain four cables 110 often does not allow for the incorporation of a retention portion 444 or wireless tag 446 without preventing the availability of other interconnect ports adjacent to the quad connection 460. As illustrated in FIG. 4, a single clip body 462 occupies more than the area of the constituent ports 420 and/or port identifier, as illustrated by segmented box 464 that is hidden behind a portion of the quad cable clip 462. Thus, quad cable connections 460 may pose particular difficulties in physically securing four separate cables 110 and providing a retention means for a wireless tag 444 to be incorporated without inhibiting use of adjacent interconnect ports 230/240/410/420.

Hence, wireless tags 444 can provide efficient port and/or cable identification, but suffer from difficulties in physically positioning wireless tags on a cable clip, particularly in duplex/quad configurations where space between ports is tight. With the size of a duplex or quad cable clip posing physical difficulties and/or inefficiencies, along with the challenges associated with incorporating wireless tags in some multi-cable clips, various embodiments are directed to a modular cable clip that allows for selective placement of a wireless tag on various locations on a cable clip that concurrently supports multiple cables 110.

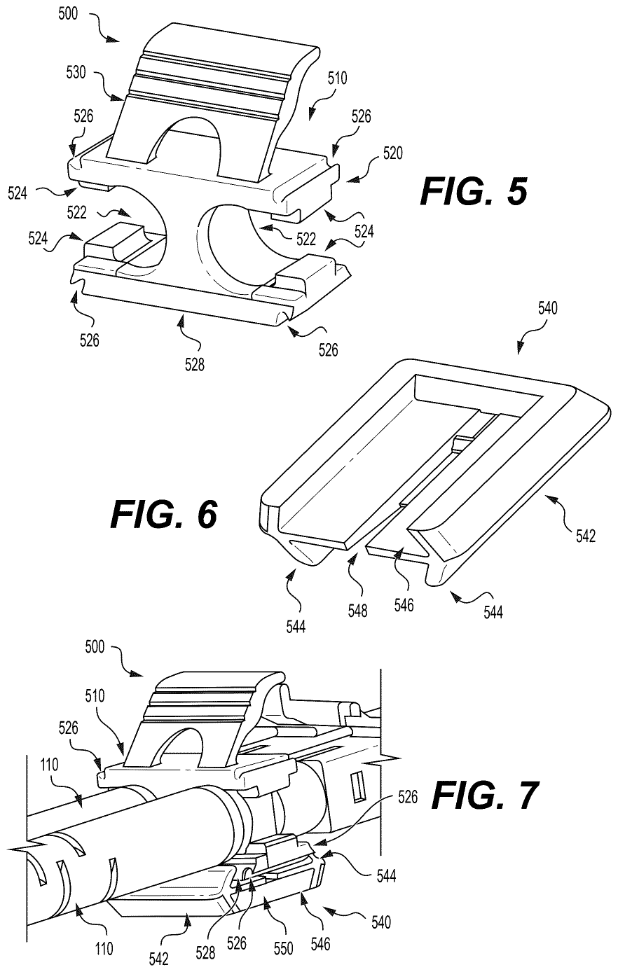

FIGS. 5-17 respectively convey assorted aspects of duplex fiber optic connectors that can be employed to provide an efficient, wireless tag support for a cable clip. The perspective views of FIGS. 5-9 respectively convey aspects of a duplex connector assembly 500 that can be employed to connect to an interconnect as part of the cable assembly 400 of FIG. 4 in accordance with various embodiments. In FIG. 5, an exemplary body portion 510 is illustrated that can house and physically retain multiple cables 110, as shown in FIGS. 7-9, to allow for efficient duplex cable connections.

The view of FIG. 5 displays how the body portion 510, for example, a unitary cable clip body 510 may be arranged to define separate cable regions 520 that can respectively hold a cable 110, or cable connector 250, during installation, removal, and operation of a connection with interconnect ports. Each cable region 520 has a cable holding portion 522 that is configured to partially surround a cable 110 in a manner that allows physical retention. As illustrated, the cable holding portion 522 includes a first cable holding portion and a second cable holding portion aligned with one another along a transverse axis of the body portion. The body portion 510 includes a middle portion between the first cable holding portion and the second cable holding portion.

The cable holding portion 522 may include a first cable engaging portion and a second cable engaging portion disposed parallel to one another and spaced apart from one another to define the first cable holding portion that is structurally configured to hold a first fiber optic cable, and which may be accessible via a first cable receiving portion structurally configured to receive the first fiber optic cable. The cable holding portion may include a third cable engaging portion and a fourth cable engaging portion disposed parallel to one another and spaced apart from one another to define the second cable holding portion configured to hold a second fiber optic cable, which may be accessible via a second cable receiving portion structurally configured to receive a second fiber optic cable.

The cable holding portion 522 may be accessible in a transverse direction via a cable receiving portion or cable opening. A cable retaining portion 524, for example, a pair of cable retention protrusions, may be rigid or flexible to allow for efficient installation of a cable 110 into a cable holding portion 522 and retention of the cable in the cable holding portion 522, while also permitting removal of the cable from the cable holding portion 522.

The body portion 510 includes an identifier retaining portion coupling portion. In some aspects, the identifier retaining portion coupling portion may include a first coupling portion, a second coupling portion, and a third coupling portion. For example, the first and second coupling portion may be provided by retention notches 526 positioned at opposite corners, as shown. A third coupling portion may be provided at a bottom surface of the body portion 510, for example, via a retention ridge portion 528. On an opposite top body surface, a connector engagement portion 530 allows for multiple connectors 250 to be selected concurrently. It is noted that the body portion 510 is configured with transverse symmetry about a centerline, but such configuration is not required or limiting.

FIG. 6 illustrates portions of a retention portion 540 that can be employed with the retention notches 526 or retention ridge portion 528 to provide the ability to attach one or more wireless tags to the clip body 510 in a diverse assortment of orientations. The retention portion 540 has a retention body 542 that provides a pair of retention tabs 544 as well as a retention region 546. Although not required, the retention region 546 may provide one or more physical retention features 548 that aid in the alignment and/or physical securement of a wireless tag within the retention body 542.

As illustrated in FIG. 7, the tabs 544 of the retention portion 540 can engage the retention ridge portion 528 to secure the retention body 542 to the bottom surface of the body portion 510 with the retention region 546 facing a direction orthogonal to the longitudinal axis of the respective cables 110. The retention region 546 is shown in FIG. 7 occupied by a wireless tag 550, but the size and configuration of the tag 550 is not required or limiting. It is noted that the engagement of the retention tabs 544 with the retention ridge portion 528 leaves the respective retention notches 526 exposed and unused.

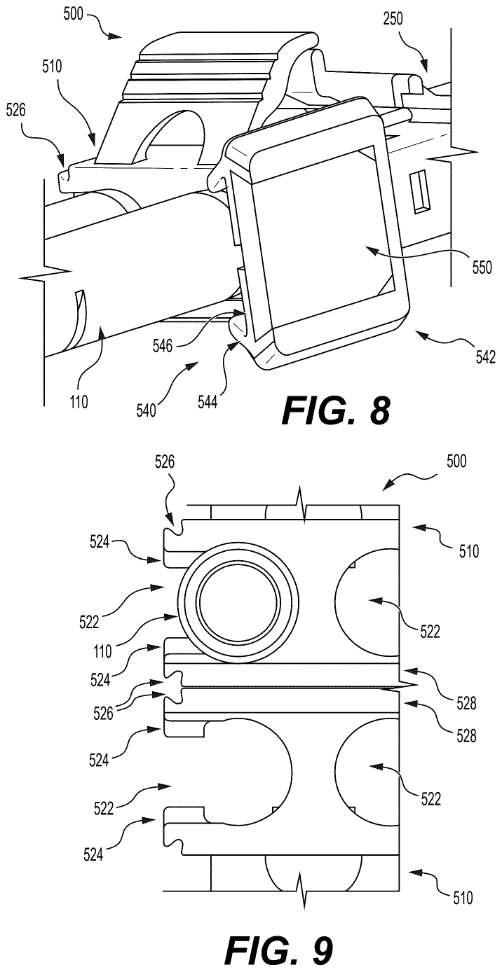

FIG. 8 conveys how a pair of retention notches 526 can be occupied by the retention tabs 544 of the retention portion 540 to orient the retention region 546 parallel to the longitudinal axis of the respective cables 110. Comparison of retention portion 540 configuration of FIGS. 7 and 8 illustrates how the assorted aspects of the body portion 510 can be selectively employed to position and orient the retention portion 540 in a variety of different arrangements. While available to engage and physically secure a retention portion 540 with notches 526, or the retention ridge 528, may not inhibit the ability to combine two clip bodies 510 to form a quad cable connection configuration, as shown in FIG. 9.

The front perspective view of FIG. 9 conveys how a body portion 510 can interact with another, matching body portion 510 to provide support for up to four cables 110. The presence of the retention ridges 528 and retention notches 526 allow for selective physical attachment of the respective cable clip bodies 510 by concurrently engaging the ridges 528 and/or notches 526 of adjoining clip body portions 510. That is, a technician may utilize separate, matching duplex cable clips to provide a single quad cable connector clip by physically attaching one or more retention features that contact the retention ridges 528 along a first direction, retention notches 526 along a second direction that is orthogonal to the first direction, or both of the respective cable clip bodies 510.

As a result of joining body portions 510, both horizontal pitch 260 and vertical pitch 280 of four cables 110 can be reliably maintained over time while providing several different manners of attaching a wireless tag that identifies the cables 110, connected ports 420, or both. The ability to join multiple separate cable clip bodies 510 together to form a unitary quad cable connection clip is not required or limiting. Thus, some embodiments of a body portion 510 may be configured for duplex operation alone while other embodiments may join body portions 510 with different sizes, shapes, or features to form a unitary quad cable connection clip.

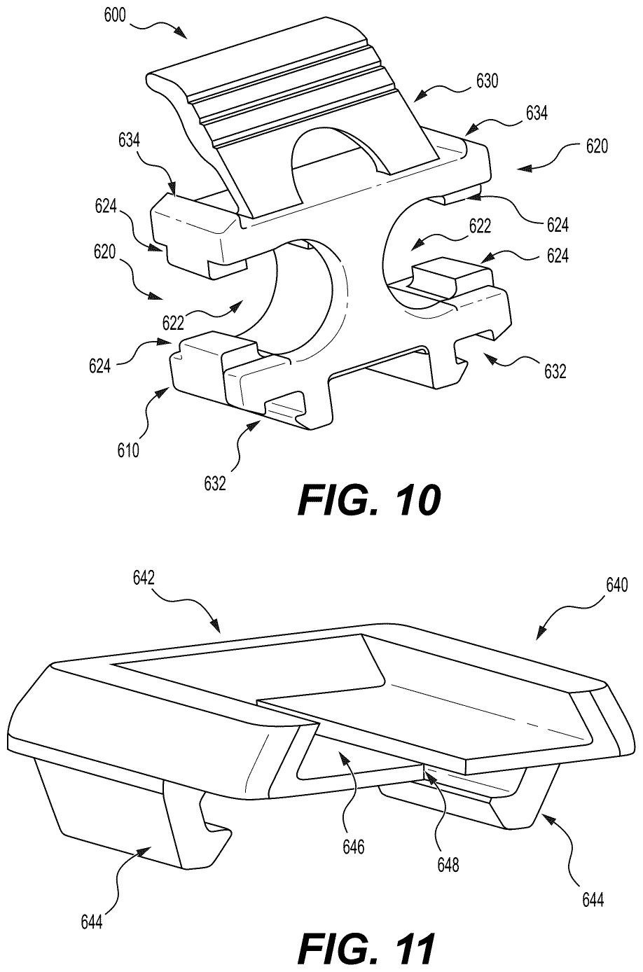

FIGS. 10-13 respectively illustrate aspects of an exemplary duplex connector assembly 600 that employs at least one duplex cable clip to provide wireless labeling of portions of a distributed signal network. FIG. 10 conveys a duplex body portion 610 that can be employed to provide physical retention of up to two separate cables 110, as generally illustrated in FIG. 7. The body portion 610 has separated cable regions 620 that each have a cable holding portion 622 and a pair of cable retention protrusions 624. A connector engagement portion 630 allows for concurrent physical engagement of cable connectors 250, such as release levers extending from each connector 250. As illustrated, the cable holding portion 622 includes a first cable holding portion and a second cable holding portion aligned with one another along a transverse axis of the body portion. The body portion 610 includes a middle portion between the first cable holding portion and the second cable holding portion.

The cable holding portion 622 may include a first cable engaging portion and a second cable engaging portion disposed parallel to one another and spaced apart from one another to define the first cable holding portion that is structurally configured to hold a first fiber optic cable, and which may be accessible via a first cable receiving portion structurally configured to receive the first fiber optic cable. The cable holding portion may include a third cable engaging portion and a fourth cable engaging portion disposed parallel to one another and spaced apart from one another to define the second cable holding portion configured to hold a second fiber optic cable, which may be accessible via a second cable receiving portion structurally configured to receive a second fiber optic cable.

The cable holding portion 622 may be accessible in a transverse direction via a cable receiving portion or cable opening. A cable retaining portion, for example, a pair of cable retention protrusions, may be rigid or flexible to allow for efficient installation of a cable 110 into a cable holding portion 622 and retention of the cable in the cable holding portion 622, while also permitting removal of the cable from the cable holding portion 622.

The body portion 610 includes an identifier retaining portion coupling portion. In some aspects, the identifier retaining portion coupling portion may including a first coupling portion, a second coupling portion, and a third coupling portion. For example, the first and second coupling portions may be provided by retention notches positioned at opposite corners, as shown. A third coupling portion may be provided at a bottom surface of the body portion 610, for example, via a retention ridge portion. On an opposite top body surface, a connector engagement portion may allow for multiple connectors 250 to be selected concurrently. It is noted that the body portion 610 is configured with transverse symmetry about a centerline, but such configuration is not required or limiting.

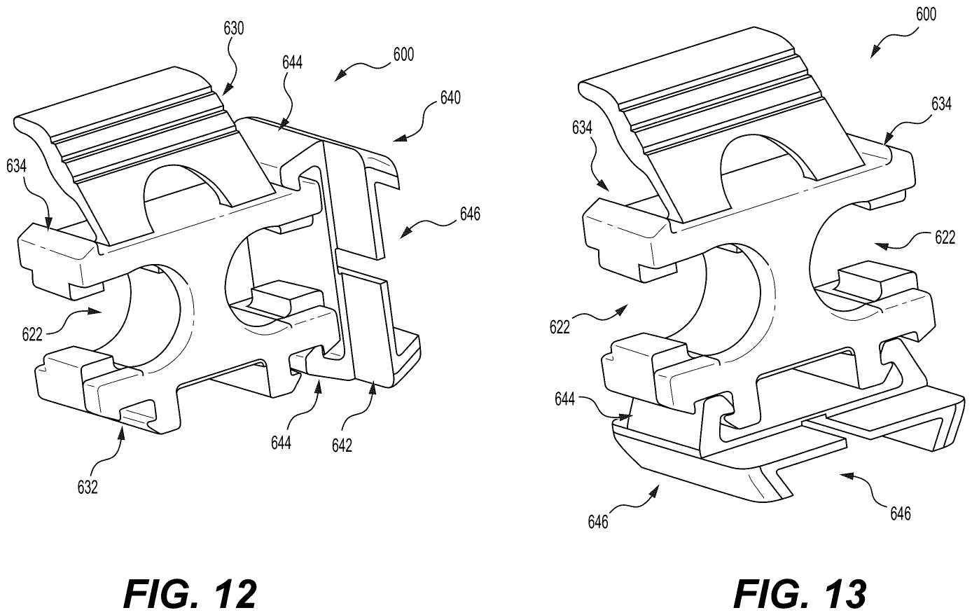

The body portion 610 additionally has a number of retention features that can be selectively utilized to attach one or more wireless retention portion 640 in desired positions and orientations relative to the cable regions 622. A retention feature may include retention ridges 632 on various positions on the body portion 610, as shown. The respective retention ridges 632 are not limited to a particular size, shape, or orientation, but may include one or more tapered surfaces and/or cantilevered protrusions that aid in the engagement and retention of a retention portion 640, as generally illustrated in FIGS. 12 and 13.

FIG. 11 conveys portions of a retention portion 640 that can engage and secure to the body portion 610. A retention body 642 allows for one or more wireless tags to be installed while a pair of retention tabs 644 allow for installation of the portion 640 onto the body portion 610. Each retention tab 644 comprises a general hook shape that allows for sliding or push engagement with a pair of retention ridges 632 to secure the retention portion 640 onto the body portion 610 for any desired amount of time. For instance, the retention portion 640 may be installed by temporarily flexing the retention tabs 644 and/or ridges 632 through the application of pushing force. Another instance slides the retention tabs 644 into contact with the retention ridges 632 without deforming either the tabs 644 or ridges 632.

The retention portion body 642 may define one or more wireless tag retention regions 646 that may additionally have a tag retention feature 648, such as a slot, keyed opening, groove, ridge, or other attachment mechanism. It is noted that the respective retention tabs 644 may be constructed with matching, or dissimilar, configurations, such as size, shape, material, position, or orientation on the body 642 to be able to selectively engage aspects of a body portion 610 to install, or remove, the retention portion 640 from the body portion 610.

FIGS. 12 and 13 respectively illustrate non-limiting configurations where the retention portion 640 of FIG. 11 is installed onto the body portion 610 of FIG. 10 to provide a wireless tag caddy. In FIG. 12, the retention portion 640 engages retention ridges 632 on opposite sides of a cable opening 622 to position the wireless tag retention region 646 on a selected side of the body portion 610. It is noted that the retention portion 640 may be oriented in one or more directions by engaging the retention ridges 632 in the manner shown in FIG. 12.

By engaging the retention ridges 632 along a bottom surface of the body portion 610, opposite the connector engagement portion 630 and adjacent retention ridges 634 along a top surface of the body portion 610, the retention portion 640 may be secured below each of the cable regions 622 while allowing continuous access to the cable regions 622, which may allow for efficient adjustment of individual cables 110 compared to the retention portion 640 arrangement shown in FIG. 12. The configuration of the retention tabs 644 and ridges 632 can allow for installation, removal, and alteration of the position, orientation, and presence of the retention portion 640 over time. As such, the retention portion 640 may be altered on the body portion 610 to accommodate dynamic port, cable, and/or interconnect arrangements that occur.

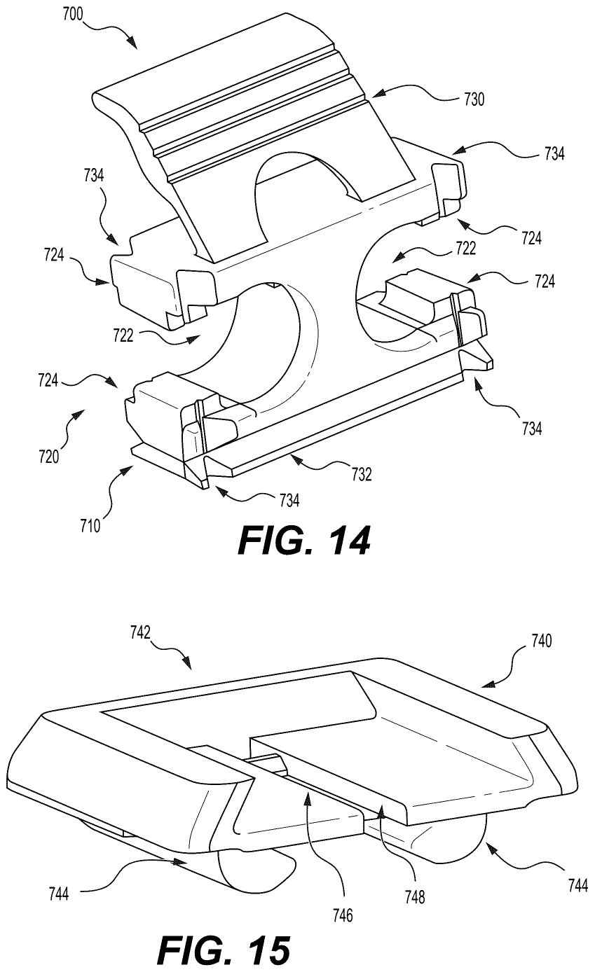

A cable clip system is not limited to the body portion 510/610 or retention portion 540/640 configurations shown in FIGS. 5-13. Accordingly, FIGS. 14-17 respectively convey aspects of another, non-limiting, cable clip system 700 that is configured to provide selective installation, position, and orientation of one or more wireless tags that can indicate information about a cable, port, and/or connection. A cable clip is shown in FIG. 14 that has a unitary body portion 710 with separate cable regions 720 defining cable holding portions 722 with retention protrusions 724 that are collectively sized and shaped to secure at least one cable 110. As illustrated, the cable holding portion 722 includes a first cable holding portion and a second cable holding portion aligned with one another along a transverse axis of the body portion. The body portion 710 includes a middle portion between the first cable holding portion and the second cable holding portion.

The cable holding portion 722 may include a first cable engaging portion and a second cable engaging portion disposed parallel to one another and spaced apart from one another to define the first cable holding portion that is structurally configured to hold a first fiber optic cable, and which may be accessible via a first cable receiving portion structurally configured to receive the first fiber optic cable. The cable holding portion may include a third cable engaging portion and a fourth cable engaging portion disposed parallel to one another and spaced apart from one another to define the second cable holding portion configured to hold a second fiber optic cable, which may be accessible via a second cable receiving portion structurally configured to receive a second fiber optic cable.

The cable holding portion 722 may be accessible in a transverse direction via a cable receiving portion or cable opening. A cable retaining portion, for example, a pair of cable retention protrusions, may be rigid or flexible to allow for efficient installation of a cable 110 into a cable holding portion 722 and retention of the cable in the cable holding portion 722, while also permitting removal of the cable from the cable holding portion 722.

The body portion 710 includes an identifier retaining portion coupling portion. In some aspects, the identifier retaining portion coupling portion may including a first coupling portion, a second coupling portion, and a third coupling portion. For example, the first and second coupling portions may be provided by retention notches positioned at opposite corners, as shown. A third coupling portion may be provided at a bottom surface of the body portion 710, for example, via a retention ridge portion. On an opposite top body surface, a connector engagement portion may allow for multiple connectors 250 to be selected concurrently. It is noted that the body portion 710 is configured with transverse symmetry about a centerline, but such configuration is not required or limiting.

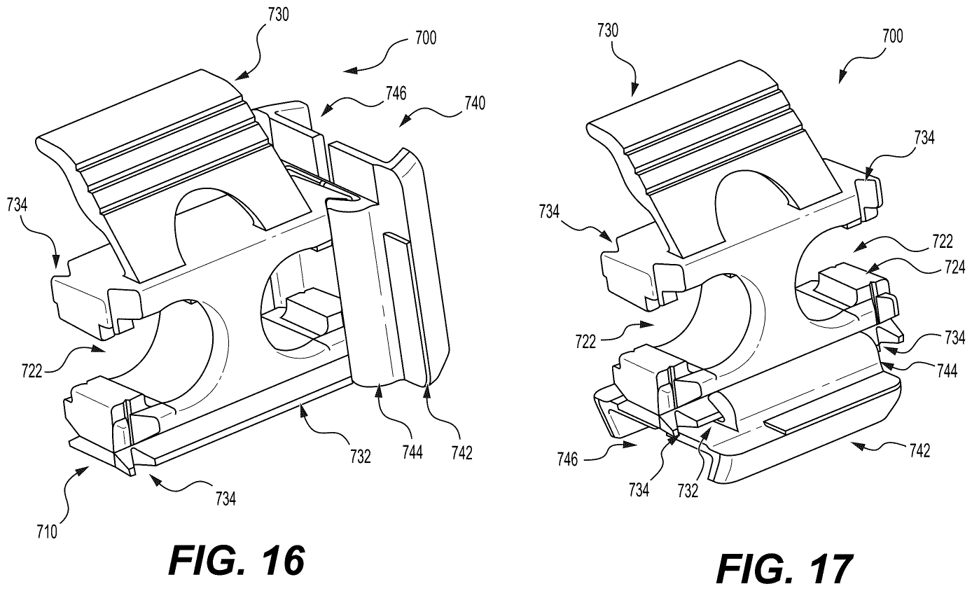

A connector engagement portion 730 is positioned on a first side of the body portion 710 while several different attachment features are positioned on a bottom side of the body portion 710, opposite the connector engagement portion 730. Such attachment features may include a retention ridge 732 and retention grooves 734. In comparison to the retention notches 526 of the body portion 510 in FIGS. 5-9, the retention grooves 734 are different sizes, shapes, and orientations relative to the body portion 710. Consequently, a retention portion 740 may be oriented vertically on one side of the body portion 710, as shown in FIG. 16, which is an orthogonal orientation compared to the body portion 510 configuration that provides retention notches 526, as shown in FIG. 8.

The different retention configurations of the respective body portions 510/610/710 may provide different retention portion 540/640/740 positions, orientations, and/or retention strength. The variety of possible retention configurations possible for a duplex body portion 510/610/710 further allow for customization of the space a duplex, or quad, cable connection takes on an interconnect 140. That is, different structural features that serve to hold and retain a retention portion 540/640/740 may correspond with varying volumes and shapes that occupy different amounts of real estate around ports 410/420 of an interconnect 140. Accordingly, structurally configuring a body portion 510/610/710 with retention features, as generally illustrated, may provide a customization of the location and orientation of a retention portion 540/640/740 as well as the volume of space occupied on an interconnect 140 during use.

FIG. 15 conveys a perspective view of aspects of a retention portion 740 that may be employed to support a wireless tag in cooperation with the body portion 710. A retention body 742 has a pair of retention tabs 744 that are each structurally configured to mate with the retention ridge 732 and retention grooves 734 of the body portion 710 to securely join the retention portion 740 for a selected amount of time. The retention body 742 defines a retention region 746 in which a wireless tag may be selectively placed and retained. The retention region 746 may contain any number of alignment and/or attachment features, such as a groove, notch, ridge, or fastener.

In accordance with various embodiments, the retention tabs 744 may allow engagement with a selected side of the body portion 710. FIGS. 16 and 17 respectively illustrate how the retention portion 740 may engage the body portion 710 to provide different retention region 746 positions and orientations. It is noted that an orientation of a retention portion 540/640/740 may be characterized by the direction in which a wireless tag can be inserted into the retention body 542/642/742.

The ability to selectively install the retention portion 740 onto the body portion 710 to provide a particular retention region 746 orientation corresponds with overall duplex connector assembly 500/600/700 configurations that is catered to the environment, and interconnect 140 configuration, to provide optimized cable organization, management, physical support, and identification. The structural configuration of a duplex connector assembly 500/600/700 may further provide the ability to adapt the position and/or orientation of a retention portion 540/640/740 over time. For instance, a retention portion 740 may be turned or moved to a different position/orientation after being installed and utilized to wirelessly identify a port in which a cable 110 retained by the body portion 710. Such adaptability of a retention portion 740 relative to a body portion 710 allows a single body portion 710, or multiple bodies joined to form a unitary quad connector, to be transformed over time instead of being replaced, which increases the cable management efficiency of an interconnect 140.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A duplex fiber optic connector configured to enhance fiber identification and cable management, comprising:
a body portion structurally configured to include a cable holding portion and an identifier retaining portion coupling portion;
wherein the cable holding portion includes a first cable engaging portion and a second cable engaging portion disposed parallel to one another and spaced apart from one another to define a first cable receiving portion structurally configured to receive a first fiber optic cable and a first holding portion structurally configured to hold the first fiber optic cable;
wherein the cable holding portion includes a third cable engaging portion and a fourth cable engaging portion disposed parallel to one another and spaced apart from one another to define a second cable receiving portion structurally configured to receive a second fiber optic cable and a second holding portion structurally configured to hold the second fiber optic cable;
wherein the body portion includes a middle portion between the first cable holding portion and the second cable holding portion;
wherein the first cable holding portion is aligned with the second cable holding portion along a transverse axis of the body portion;
wherein the first cable receiving portion and the second cable receiving portion are disposed at opposite sides of the body portion along the transverse axis such that the first cable receiving portion and the second cable receiving portion are structurally configured to receive a fiber optic cable in a direction of the transverse axis;
wherein the identifier retaining portion coupling portion includes a first coupling portion, a second coupling portion, and a third coupling portion;
wherein the first cable engaging portion and the second cable engaging portion are structurally configured to provide the first coupling portion at the first cable receiving portion;
wherein the third cable engaging portion and the fourth cable engaging portion are structurally configured to provide the second coupling portion at the second cable receiving portion;
wherein the second cable engaging portion and the fourth cable engaging portion are structurally configured to provide the third coupling portion at a bottom portion of the body portion; and
wherein the first coupling portion is structurally configured to slidingly receive an identifier retaining portion in a first orientation, the second coupling portion is structurally configured to slidingly receive the identifier retaining portion in a second orientation, and the third coupling portion is structurally configured to receive the identifier retaining portion in a third orientation such that the identifier retaining portion coupling portion permits selective attachment of the identifier retaining portion in the first orientation, the second orientation, or the third orientation so as to enhance fiber identification and cable management.

2. The duplex connector of claim 1, wherein the third coupling portion is structurally configured to receive a second same duplex connector to provide a quad cable configuration.

3. A duplex connector assembly, comprising:
the duplex connector of claim 1; and
an identifier retaining portion structurally configured to retain a cable identifier.

4. The duplex connector assembly of claim 3, further comprising a cable identifier configured to be received by the identifier retaining portion.

5. The duplex connector assembly of claim 4, wherein the cable identifier comprises an RFID tag.

6. A duplex fiber optic connector configured to enhance fiber identification and cable management, comprising:
a body portion structurally configured to include a cable holding portion and an identifier retaining portion coupling portion;
wherein the cable holding portion includes a first cable engaging portion and a second cable engaging portion disposed parallel to one another and spaced apart from one another to define a first cable holding portion structurally configured to hold a first fiber optic cable;
wherein the cable holding portion includes a third cable engaging portion and a fourth cable engaging portion disposed parallel to one another and spaced apart from one another to define a second cable holding portion structurally configured to hold a second fiber optic cable;
wherein the identifier retaining portion coupling portion includes a first coupling portion, a second coupling portion, and a third coupling portion;
wherein the first cable engaging portion and the second cable engaging portion are structurally configured to provide the first coupling portion;
wherein the third cable engaging portion and the fourth cable engaging portion are structurally configured to provide the second coupling portion;
wherein the second cable engaging portion and the fourth cable engaging portion are structurally configured to provide the third coupling portion at a bottom portion of the body portion; and
wherein the first coupling portion is structurally configured to slidingly receive an identifier retaining portion in a first orientation, the second coupling portion is structurally configured to slidingly receive the identifier retaining portion in a second orientation, and the third coupling portion is structurally configured to receive the identifier retaining portion in a third orientation such that the identifier retaining portion coupling portion permits selective attachment of the identifier retaining portion in the first orientation, the second orientation, or the third orientation so as to enhance fiber identification and cable management.

7. The duplex connector of claim 6, wherein the first cable holding portion is aligned with the second cable holding portion along a transverse axis of the body portion; and
wherein the first cable holding portion and the second cable holding portion are disposed at opposite sides of the middle portion along the transverse axis such that the first cable holding portion and the second cable holding portion are structurally configured to receive a fiber optic cable in a direction of the transverse axis.

8. The duplex connector of claim 6, wherein the first coupling portion is disposed at an opening to the first cable holding portion, and the second coupling portion is disposed at an opening to the second cable holding portion.

9. The duplex connector of claim 6, wherein the third coupling portion is structurally configured to receive a second same duplex connector to provide a quad cable configuration.

10. A duplex connector assembly, comprising:
the duplex connector of claim 6; and
an identifier retaining portion structurally configured to retain a cable identifier.

11. The duplex connector assembly of claim 10, further comprising a cable identifier configured to be received by the identifier retaining portion.

12. The duplex connector assembly of claim 11, wherein the cable identifier comprises an RFID tag.

13. A duplex fiber optic connector configured to enhance fiber identification and cable management, comprising:
a body portion structurally configured to include a cable holding portion;
wherein the cable holding portion includes a first cable holding portion structurally configured to hold a first fiber optic cable and a second cable holding portion structurally configured to hold a second fiber optic cable;
wherein the first cable holding portion is structurally configured to provide a first coupling portion;
wherein the second cable holding portion is structurally configured to provide a second coupling portion;
wherein the first cable holding portion and the second cable holding portion are structurally configured to provide a third coupling portion; and
wherein the first coupling portion is structurally configured to slidingly receive an identifier retaining portion in a first orientation, the second coupling portion is structurally configured to slidingly receive the identifier retaining portion in a second orientation, and the third coupling portion is structurally configured to receive the identifier retaining portion in a third orientation such that the first, second, and third coupling portions permit selective attachment of the identifier retaining portion in the first orientation, the second orientation, or the third orientation so as to enhance fiber identification and cable management.

14. The duplex connector of claim 13, wherein the cable holding portion includes a first cable engaging portion and a second cable engaging portion disposed parallel to one another and spaced apart from one another to define the first cable holding portion; and
wherein the cable holding portion includes a third cable engaging portion and a fourth cable engaging portion disposed parallel to one another and spaced apart from one another to define the second cable holding portion.

15. The duplex connector of claim 13, wherein the first cable holding portion is aligned with the second cable holding portion along a transverse axis of the body portion; and
wherein the first cable holding portion and the second cable holding portion are disposed at opposite sides of the middle portion along the transverse axis such that the first cable holding portion and the second cable holding portion are structurally configured to receive a fiber optic cable in a direction of the transverse axis.

16. The duplex connector of claim 13, wherein the first coupling portion is disposed at an opening to the first cable holding portion, and the second coupling portion is disposed at an opening to the second cable holding portion.

17. The duplex connector of claim 13, wherein the third coupling portion is structurally configured to receive a second same duplex connector to provide a quad cable configuration.

18. A duplex connector assembly, comprising:
the duplex connector of claim 13; and
an identifier retaining portion structurally configured to retain a cable identifier.

19. The duplex connector assembly of claim 18, further comprising a cable identifier configured to be received by the identifier retaining portion.

20. The duplex connector assembly of claim 19, wherein the cable identifier comprises an RFID tag.
